(19) United States
(12) Patent Application Publication
(10) Pub. No.: US 2022/0318045 A1
(43) Pub. Date: Oct. 6, 2022

(54) INFORMATION PROCESSING SYSTEM, COMPUTER-READABLE RECORDING MEDIUM STORING INFORMATION PROCESSING PROGRAM AND INFORMATION PROCESSING METHOD

(71) Applicant: FUJITSU LIMITED, Kawasaki-shi (JP)

(72) Inventor: Katsuaki Nakamura, Kawasaki (JP)

(73) Assignee: FUJITSU LIMITED, Kawasaki-shi (JP)

(21) Appl. No.: 17/589,605

(22) Filed: Jan. 31, 2022

(30) Foreign Application Priority Data
Mar. 31, 2021 (JP) 2021-059229

(51) Int. Cl. G06F 9/455; G06F 8/65

(52) U.S. Cl. CPC G06F 9/45558; G06F 8/65; G06F 2009/45587; G06F 2009/45595; G06F 2009/45583

(57) ABSTRACT

An information processing system includes: information processing apparatuses; and a management apparatus that is coupled to the information processing apparatuses via a first transfer path. Each information processing apparatus is configured to: estimate a probability of downloading update data via the first transfer path based on history information that indicates via which one of the first transfer path and a second transfer path the update data that corresponds to a program that operates in the information processing apparatus has been downloaded; transmit index information that corresponds to an estimation result of the probability to the management apparatus; receive classification information that indicates to which of groups the information processing apparatus is classified from the management apparatus; determine a group to which the information processing apparatus belongs out of the groups based on the classification information; and download the update data at a timing that corresponds to the determined group.

### CROSS-REFERENCE TO RELATED APPLICATION

This application is based upon and claims the benefit of priority of the prior Japanese Patent Application No. 2021-59229, filed on Mar. 31, 2021, the entire contents of which are incorporated herein by reference.

### FIELD

The embodiments discussed herein are related to an information processing system, a computer-readable recording medium storing a program, a method, and a management apparatus.

### BACKGROUND

An information processing system for companies and the like has to appropriately manage the security status of each device in the system. For example, security of the information processing system may be improved by appropriately managing the application status of a security patch in each device.

Japanese Laid-open Patent Publication No. 2006-184936 and International Publication Pamphlet No. WO 2004/009428 are disclosed as related art.

### SUMMARY

According to an aspect of the embodiments, an information processing system includes: a plurality of information processing apparatuses each including a first processor; and a management apparatus that includes a second processor and is coupled to the plurality of information processing apparatuses via a first transfer path. The first processor of each of the plurality of information processing apparatuses is configured to: estimate a probability of downloading update data via the first transfer path based on history information that indicates via which one of the first transfer path and a second transfer path the update data that corresponds to a program that operates in the information processing apparatus has been downloaded; transmit index information that corresponds to an estimation result of the probability to the management apparatus; receive classification information that indicates to which of a plurality of groups the information processing apparatus is classified from the management apparatus; determine a group to which the information processing apparatus belongs out of the plurality of groups based on the classification information; and download the update data at a timing that corresponds to the determined group. The second processor of the management apparatus configured to: classify each of the plurality of information processing apparatuses into one of the plurality of groups based on the index information received from each of the plurality of information processing apparatuses; and transmit the classification information that indicates the classification result to the plurality of information processing apparatuses.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example and a processing example of an information processing system according to a first embodiment;

FIG. 2 is a diagram illustrating a configuration example of an information processing system according to a second embodiment;

FIG. 3 is a diagram illustrating a hardware configuration example of a PC;

FIG. 4 is a diagram illustrating a configuration example of processing functions that a management server and the PC have;

FIG. 5 is a diagram illustrating a data configuration example of a management table stored in the management server;

FIG. 6 is a diagram illustrating an overview of processing for setting registries used for grouping;

FIG. 7 is a diagram illustrating label assigning processing;

FIG. 8 is a diagram illustrating label grouping processing;

FIG. 9 is a diagram illustrating a patch application timing for each group;

FIG. 10 is an example of a flowchart illustrating a procedure of OS check command transmission processing by the management server;

FIG. 11 is an example of a flowchart illustrating a procedure of group notification processing;

FIG. 12 is an example of a flowchart illustrating a procedure of OS check processing by the PC;

FIG. 13 is an example of a flowchart illustrating a procedure of environment check processing by the PC; and

FIG. 14 is an example of a flowchart illustrating a procedure of patch application processing by the PC.

### DESCRIPTION OF EMBODIMENTS

As for the security management, the following techniques have been proposed. For example, an information system setting device has been proposed that determines policy information on security based on attribute information of a user and property information of a terminal device and creates setting information of each device in the information system based on the policy information. A system has been proposed in which, instead of a server transmitting a patch to each computer in a remote office via a virtual private network (VPN), the patch is transmitted from the server to a relay and distributed from the relay to another computer, thereby removing a VPN bottleneck for a remote group over the network.

In many cases, secure communication is performed using a VPN between an apparatus over an internal network in an organization such as a company and an apparatus over an external network such as the Internet. For example, when an information processing apparatus (a terminal device of an employee or the like) coupled to an external network downloads update data of a program from a management apparatus over an internal network, the download is performed via a VPN.

In recent years, along with popularization of telework, the number of information processing apparatuses coupled to an external network to be used has increased. For this reason, a communication load using a VPN increases when these information processing apparatuses download update data of a program. As a method of reducing the communication load at the time of downloading update data, for example, a method is conceivable in which the information processing apparatuses are classified into multiple groups, and download timings are staggered for each group. However, there is a problem that the communication load of a VPN may not be evenly distributed by merely grouping the same number of information processing apparatuses, and the reduction amount of the communication load may be insufficient depending on the download timing.

In one aspect, an object of the embodiments is to provide an information processing system, a program, a method, and a management apparatus that are capable of reducing a download load of update data.

Embodiments of the present disclosure will be described below with reference to the drawings.

### First Embodiment

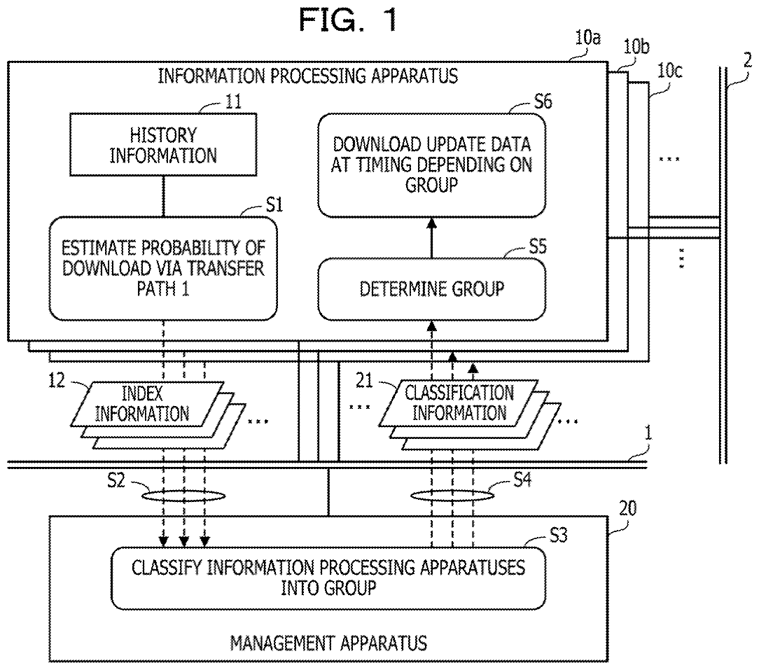

FIG. 1 is a diagram illustrating a configuration example and a processing example of an information processing system according to a first embodiment. The information processing system illustrated in FIG. 1 includes information processing apparatuses 10a, 10b, 10c, . . . and a management apparatus 20. The information processing apparatuses 10a, 10b, 10c, . . . and the management apparatus 20 are coupled to each other via a transfer path 1. The information processing apparatuses 10a, 10b, 10c, . . . are also coupled to a transfer path 2 different from the transfer path 1.

Each of the information processing apparatuses 10a, 10b, 10c, . . . is capable of downloading update data corresponding to a program operating in the corresponding information processing apparatus via either of the transfer paths 1 and 2. For example, in a case of downloading via the transfer path 1, the update data is downloaded from the management apparatus 20. On the other hand, in a case of downloading via the transfer path 2, the update data is downloaded from a download source device (for example, a web server of a vendor of the program) different from a download source device in the case of downloading via the transfer path 1.

In order to equalize download loads of the update data via the transfer path 1 as much as possible, the management apparatus 20 classifies the information processing apparatuses 10a, 10b, 10c, . . . into multiple groups, and the downloading of the update data is performed for each group. When the download loads (amounts of downloaded data) of the update data are equalized among the groups, the download loads via the transfer path 1 may be reduced the most. This is because the maximum load on the transfer path 1 during downloading may be minimized.

As a method of equalizing the download loads of the update data among groups, a method of grouping the information processing apparatuses by the same number is conceivable. However, as illustrated in FIG. 1, in a case where each of the information processing apparatuses 10a, 10b, 10c, . . . is capable of downloading the update data not only via the transfer path 1 but also via the transfer path 2, the download loads are not necessarily equalized among the groups in this method. This is because some information processing apparatuses may download the update data via the transfer path 2 without via the transfer path 1. To deal with this, in this embodiment, the probability that each of the information processing apparatuses 10a, 10b, 10c, . . . downloads the update data via the transfer path 1 is estimated, and the grouping is executed in consideration of the estimation result.

In the information processing system according to this embodiment, the grouping processing is executed in the following procedure.

Each of the information processing apparatuses 10a, 10b, 10c, . . . stores history information 11. The history information 11 holds a history indicating via which one of the transfer paths 1 and 2 the corresponding information processing apparatus has downloaded the update data. Each of the information processing apparatuses 10a, 10b, 10c, . . . executes processing in steps S1 and S2 described below by referring to the history information 11.

For example, the information processing apparatus 10a estimates the probability of downloading the update data via the transfer path 1 based on the history information 11 in the information processing apparatus 10a (step S1). The information processing apparatus 10a transmits index information 12 according to the estimation result of the probability as described above to the management apparatus 20 (step S2).

Thus, the management apparatus 20 receives the index information 12 from each of the information processing apparatuses 10a, 10b, 10c, . . . . Based on the received index information 12, the management apparatus 20 classifies each of the information processing apparatuses 10a, 10b, 10c, . . . into one of multiple groups (step S3). For example, in this classification processing, the information processing apparatuses 10a, 10b, 10c, . . . are grouped based on the index information 12 such that the total values of the probabilities of downloading the update data via the transfer path 1 are substantially equal for each group. Accordingly, as the number of information processing apparatuses belonging to a group is greater, the probability that more information processing apparatuses in the group download the update data via the transfer path 2 without via the transfer path 1 is higher. As a result, the number of information processing apparatuses that actually download the update data via the transfer path 1 is equal for each group.

The management apparatus 20 transmits classification information 21 indicating the group classification result to each of the information processing apparatuses 10a, 10b, 10c, . . . (step S4). Each of the information processing apparatuses 10a, 10b, 10c, . . . receives the classification information 21 and executes processing in steps S5 and S6 described below.

For example, the information processing apparatus 10a determines the group to which the information processing apparatus 10a belongs based on the received classification information 21 (step S5). At a timing depending on the determined group, the information processing apparatus 10a downloads the update data via the transfer path 1 and applies the update data to a corresponding program (step S6). Accordingly, the download timings of the update data are staggered for each group. However, in step S5, in a case where the same update data has already been downloaded via the transfer path 2, the download via the transfer path 1 is not performed.

With the above-described processing, it is possible to reduce the download load of the update data via the transfer path 1.

### Second Embodiment

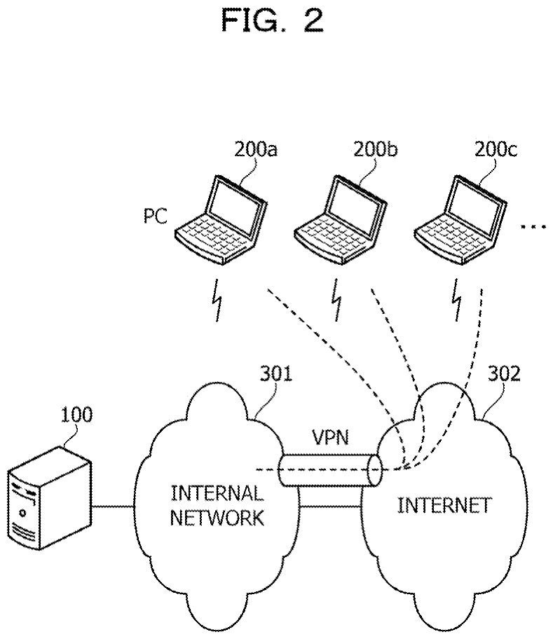

FIG. 2 is a diagram illustrating a configuration example of an information processing system according to a second embodiment. The information processing system illustrated in FIG. 2 includes a management server 100 and personal computers (PCs) 200a, 200b, 200c, . . . . The management server 100 is an example of the management apparatus 20 illustrated in FIG. 1. The PCs 200a, 200b, 200c, . . . are an example of the information processing apparatuses 10a, 10b, 10c, . . . illustrated in FIG. 1.

The management server 100 is a server apparatus that manages assets (information processing devices) owned by an organization such as a company. In this embodiment, for example, the management server 100 has a function of managing the status of executing security measures for the PCs 200a, 200b, 200c, . . . . The management server 100 is coupled to an internal network 301. The internal network 301 is a local network (intranet) used in the above-described organization. For example, the internal network 301 is coupled to the Internet 302 via a not-illustrated gateway or the like.

The PCs 200a, 200b, 200c, . . . are client computers managed by the management server 100 and are user terminals used by a user belonging to the above-described organization. The PCs 200a, 200b, 200c, . . . are capable of coupling to both the internal network 301 and Internet 302 in a wired or wireless manner. As an example, when the PCs 200a, 200b, 200c, . . . are present in a facility of the organization, the PCs 200a, 200b, 200c, . . . are coupled to the internal network 301, and when the PCs 200a, 200b, 200c, . . . are present outside the facility, the PCs 200a, 200b, 200c, . . . are coupled to the Internet 302.

However, when the PCs 200a, 200b, 200c, . . . communicate with devices over the internal network 301 such as the management server 100 via the Internet 302, these devices and the PCs 200a, 200b, 200c, . . . are coupled via a VPN. For example, a VPN access point (not illustrated) is installed over the internal network 301, and the PCs 200a, 200b, 200c, . . . are able to communicate with a device over the internal network 301 by performing encrypted communication with the VPN access point. The VPN access point is, for example, a router having a VPN server function.

In a case where the PCs 200a, 200b, 200c, . . . are indicated without a particular limitation, they may be described as a “PC 200”.

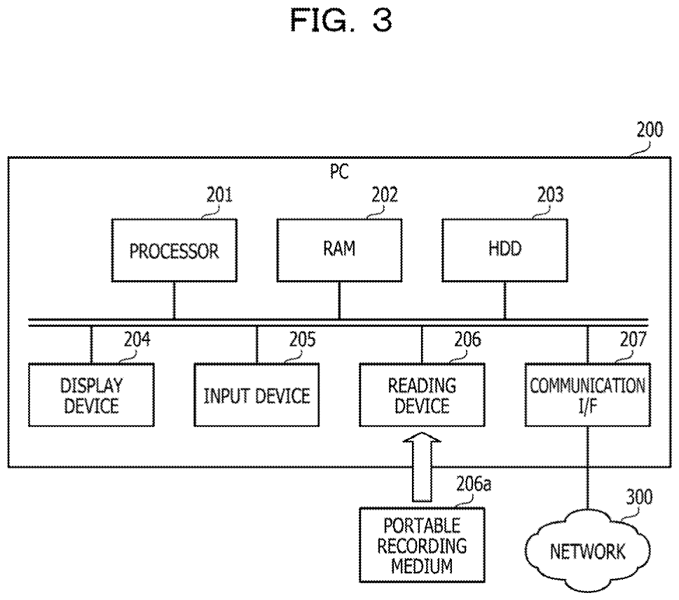

FIG. 3 is a diagram illustrating a hardware configuration example of a PC. For example, the PC 200 has the hardware configuration as illustrated in FIG. 3. The PC 200 illustrated in FIG. 3 includes a processor 201, a random-access memory (RAM) 202, a hard disk drive (HDD) 203, a display device 204, an input device 205, a reading device 206, and a communication interface (I/F) 207.

The processor 201 comprehensively controls the overall PC 200. The processor 201 is, for example, a central processing unit (CPU), a microprocessor unit (MPU), a digital signal processor (DSP), an application-specific integrated circuit (ASIC), or a programmable logic device (PLD). The processor 201 may be a combination of two or more elements out of a CPU, an MPU, a DSP, an ASIC, and a PLD.

The RAM 202 is used as a main storage device of the PC 200. The RAM 202 temporarily stores at least a part of an operating system (OS) program and an application program to be executed by the processor 201. The RAM 202 stores various types of data to be used for processing by the processor 201.

The HDD 203 is used as an auxiliary storage device for the PC 200. The HDD 203 stores the OS program, the application program, and various types of data. A different type of non-volatile storage device such as a solid-state drive (SSD) may be used as the auxiliary storage device.

The display device 204 displays an image in accordance with a command from the processor 201. The display device 204 may be a liquid crystal display, an organic electroluminescence (EL) display, or the like.

The input device 205 transmits a signal in accordance with an input operation by the user to the processor 201. The input device 205 may be a keyboard, a pointing device, or the like. The pointing device may be a mouse, a touch panel, a tablet, a touch pad, a track ball, or the like.

To and from the reading device 206, a portable recording medium 206a is attached and detached. The reading device 206 reads data recorded in the portable recording medium 206a and transmits the data to the processor 201. The portable recording medium 206a may be an optical disc, a semiconductor memory, or the like.

The communication interface 207 transmits and receives data to and from other apparatuses via a network 300. In this embodiment, the network 300 includes the internal network 301 and the Internet 302.

A hardware configuration as described above is capable of implementing processing functions of the PC 200. As in the case of the PC 200, the management server 100 may be implemented as a computer including a processor and a storage device.

The management server 100 has a function of instructing update of a program installed in the PC 200 and transmitting the update data of the program to the PC 200. In this embodiment, an OS is exemplified as the program to be updated, and the management server 100 transmits a patch (security patch and the like) of the OS to the PC 200 as the update data.

The PC 200 is capable of downloading the patch from the management server 100 in either state of being coupled to the internal network 301 or to the Internet 302. In a state of being coupled to the Internet 302, the PC 200 downloads the patch from the management server 100 via the VPN.

Due to a rapid increase in companies that encourage employees to perform so-called telework in recent years, the number of the PCs 200 coupled to the Internet 302 to be used has increased. In such a state, an amount of data of the patch downloaded via the VPN increases, and as a result, the VPN access point on a company side is overloaded, and there is the probability that a task is hindered. For example, in a case where the PC 200 coupled to the Internet 302 operates a computer over the internal network 301 with a virtual desktop, when the amount of data in the VPN increases, there is the probability that the operation of the virtual desktop becomes unstable.

To solve such a problem, it is conceivable to classify the PCs 200 into multiple groups and apply the patch to each group in a distributed manner without applying the patch to all the PCs 200 coupled to the Internet 302 at one time. In this method, the amount of the downloaded data for each group have to be as uniform as possible. By making the amount of the downloaded data uniform for each group, it is possible to efficiently use the transfer path of the VPN and to minimize the capacity for the VPN access point, and therefore the facility cost may be saved.

If the amounts of the downloaded data for each PC 200 when the patch is applied are the same, the above-described object may be easily achieved by simply grouping the PCs 200 by the same number. However, in actual patch application, the amount of the downloaded data for each PC 200 when the patch is applied is not uniform in many cases for the following reasons.

The first reason is that the type (product name or version) of the OS may be different for each PC 200. Because the patch to be applied differs depending on the type of OS, the amount of the data of the patch may differ depending on the type of OS. In such a case, the amount of the downloaded data for each group may not be uniform by simply grouping the PCs 200 by the same number.

The second reason is that, when the PC 200 is coupled to the Internet 302, there is the probability that the patch is not necessarily downloaded from the management server 100 via the VPN. Because an OS patch is usually provided from a website of an OS vendor (OS vendor site), the PC 200 may download the patch from the OS vendor site as well when the PC 200 is coupled to the Internet 302. Accordingly, when some of the PCs 200 often download the patch from the OS vendor site, the amount of the downloaded data for each group is not made uniform by simply grouping the PCs 200 by the same number. Even when grouping is performed in consideration of the amount of the data of the patch according to the difference in the type of OS, the amount of the downloaded data for each group is still not uniform.

To deal with this, in the information processing system according to this embodiment, the management server 100 and each PC 200 cooperate with each other to group the PCs 200 such that the amount of the downloaded data is as uniform as possible while taking into consideration the difference in OS version for each PC 200 and the probability that the PC 200 downloads the patch from the OS vendor site.

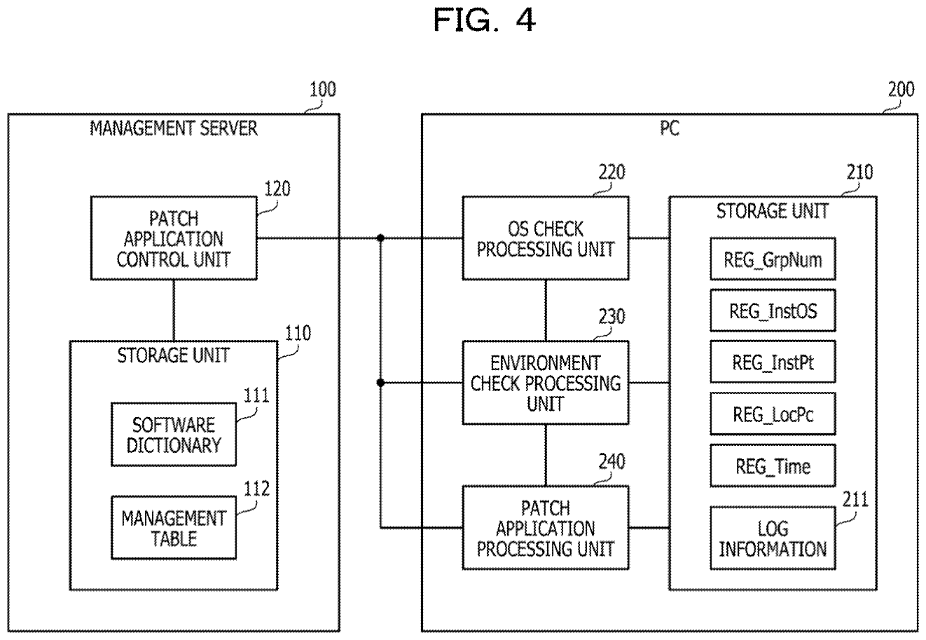

FIG. 4 is a diagram illustrating a configuration example of processing functions that the management server and the PC have.

The management server 100 includes a storage unit 110 and a patch application control unit 120.

The storage unit 110 is implemented by a storage area of a storage device included in the management server 100. The storage unit 110 stores a software dictionary 111 and a management table 112. The software dictionary 111 is a field of definition in which contents, execution conditions, and the like of programs and commands for collecting various types of information and applying the patch in the PC 200 are defined. The management table 112 stores various types of data referred to for appropriately grouping the PCs 200.

For example, processing of the patch application control unit 120 is implemented by a processor included in the management server 100 executing a predetermined application program. The patch application control unit 120 comprehensively controls the overall processing of grouping the PCs 200 and staggering the patch application timings.

For example, the patch application control unit 120 periodically and simultaneously transmits, to each PC 200, a command for checking the OS type and a command for checking the environment of the PC 200, and causes each PC 200 to check the OS type or the environment of the PC 200. The patch application control unit 120 collects information based on the check result and stores the information into the management table 112, and based on the collected information, the patch application control unit 120 groups the PCs 200 by the unit of a patch label assigned in accordance with the OS type and the patch data size. Each PC 200 is caused to autonomously determine the label assigned or the group allocated to the corresponding PC 200 while referring to the information in the management table 112. When a new patch is released, the patch application control unit 120 transmits a command for instructing the patch application to each PC 200 a number of times corresponding to the number of the groups at regular time intervals. The patch download timings are staggered for each group with the PC 200 downloading the patch in accordance with the command received in a period corresponding to the group to which the corresponding PC 200 belongs.

On the other hand, the PC 200 includes a storage unit 210, an OS check processing unit 220, an environment check processing unit 230, and a patch application processing unit 240.

The storage unit 210 is implemented by a storage area of a storage device included in the PC 200 such as the RAM 202 or the HDD 203. The storage unit 210 stores registries REG_GrpNum, REG_InstOS, REG_InstPt, REG_LocPc, and REG_Time, and log information 211.

The number (total number) of groups into which the PCs 200 are classified is set in the registry REG_GrpNum. The label of the patch corresponding to the type of the installed OS is set in the registry REG_InstOS. A value corresponding to the probability of downloading the patch via the VPN estimated from the past download status of the patch is set in the registry REG_InstPt. A value (flag) indicating whether the patch is applicable is set in the registry REG_LocPc. A value indicating the patch application timing is set in the registry REG_Time. The value set in the registry REG_Time indicates the group to which the PC 200 substantially belongs.

The log information 211 stores a past operation log in the PC 200. This log information 211 is used to determine the download status of the past patch.

Processing of the OS check processing unit 220, the environment check processing unit 230, and the patch application processing unit 240 is implemented by, for example, the processor 201 included in the PC 200 executing a predetermined application program.

The OS check processing unit 220 operates in response to reception of the OS check command for checking the OS type from the management server 100. The OS check processing unit 220 determines the type of the OS installed in the corresponding PC 200, selects one of labels of patches corresponding to the determined OS type based on the information in the management table 112, and sets the value of the selected label in the registry REG_InstOS.

The OS check processing unit 220 transmits the value set in the registry REG_InstPt to the management server 100 and causes the management server 100 to determine the group to which the PC 200 belongs by the unit of a label. The OS check processing unit 220 receives the value indicating the determined group from the management server 100 and sets the received value in the registry REG_Time.

The environment check processing unit 230 operates in response to reception of the environment check command for checking the environment of the PC 200 from the management server 100. The environment check processing unit 230 determines whether the PC 200 is coupled to the internal network 301 or the Internet 302. When coupled to the Internet 302, the environment check processing unit 230 collects download histories of the patch from the log information 211, estimates the probability of downloading the patch via the VPN from the collection result, and sets a value according to the estimation result in the registry REG_InstPt.

The environment check processing unit 230 reads the value set in the registry REG_Time and sets 1 in the registry REG_LocPc in a period corresponding to the read setting value out of periodic patch application periods. Thus, the period in which the patch is to be applied depending on the group to which the PC 200 belongs is designated.

Upon receiving the patch application command from the management server 100, the patch application processing unit 240 checks the registry REG_LocPc, and in a case where 1 is registered, downloads the patch data from the management server 100 and applies the patch data to the PC 200.

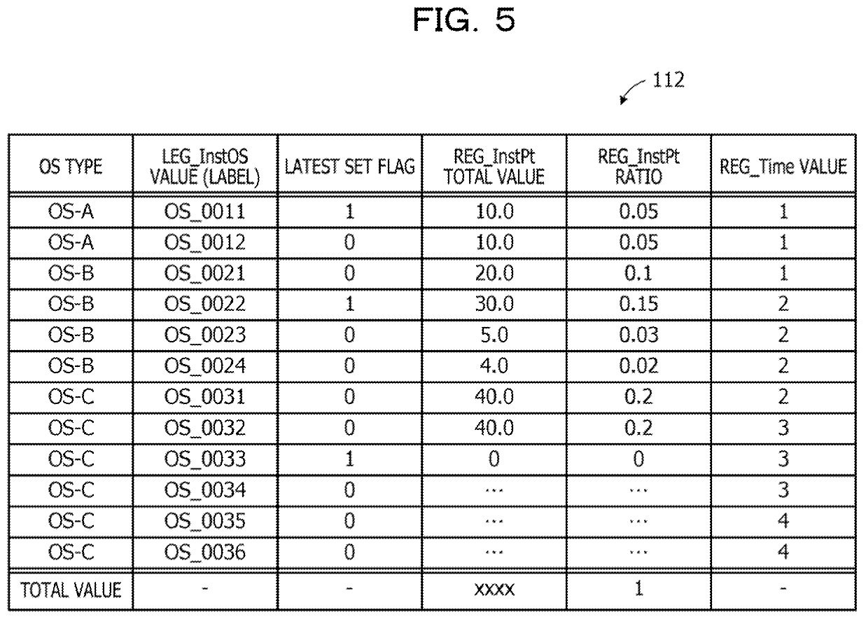

FIG. 5 is a diagram illustrating a data configuration example of the management table stored in the management server. Various types of information related to a PC 200 out of the PCs 200 that is coupled to the Internet 302 (grouping target PC) are registered in the management table 112. As illustrated in FIG. 5, the management table 112 includes respective items of OS type, LEG_InstOS value, latest set flag, REG_InstPt total value, REG_InstPt ratio, and REG_Time value.

The OS type indicates the type of the OS. As an example, in this embodiment, it is assumed that there are three OS types: OS-A; OS-B; and OS-C.

The LEG_InstOS value indicates the label related to the patch. The label is generated in advance by the management server 100 in accordance with the OS type and the data size of the patch. For example, one or more labels are generated for the same OS type. Furthermore, the number of the labels generated for each OS type is determined such that the ratio of the number of the labels for each OS type coincides with the ratio of the data size of the corresponding patch. For example, when the ratio of the data sizes of the patches respectively corresponding to the OS-A, the OS-B, and the OS-C is 1:2:3, the numbers of the labels set for the OS-A, the OS-B, and the OS-C are 1n, 2n, and 3n (n is a natural number), respectively.

In this embodiment, it is assumed that the ratio of the data sizes of the patches respectively corresponding to the OS-A, OS-B, and OS-C is 1:2:3, and n described above is 2. As illustrated in FIG. 5, it is assumed that OS_0011 and OS_0012 are generated as labels corresponding to the OS-A, OS_0021 to OS_0024 are generated as labels corresponding to the OS-B, and OS_0031 to OS_0036 are generated as labels corresponding to the OS-C.

The latest set flag is flag information indicating whether the label has been set for the PC 200 most recently. As the latest set flag, 1 is set for one of the labels corresponding to the same OS type, and 0 is set for all the remaining labels. Out of the labels corresponding to the same OS type, 1 is set for the latest set flag for the label that is set most recently for the PC 200.

Each of the grouping target PCs is assigned one of the labels corresponding to the type of the OS operating in the corresponding grouping target PC (the OS type of the corresponding grouping target PC). As will be described later, the labels are assigned to the grouping target PCs such that the same number of the PCs 200 are allocated for each label for the same OS type. The latest set flag is used for the PC 200 to autonomously execute such label assigning.

The REG_InstPt value indicates a value obtained by summing up, for each label, the values set in the registry REG_InstPt of each of the grouping target PCs. The REG_InstPt ratio indicates a ratio of the REG_InstPt value of a corresponding label to a total value obtained by summing up the REG_InstPt values of all the labels. As will be described later, the REG_InstPt ratio indicates, by a ratio, an estimated amount of the data of the patch to be downloaded via the VPN by each of the PC groups classified by the labels. The REG_Time value indicates a group classified by the unit of a label based on the REG_InstPt ratio.

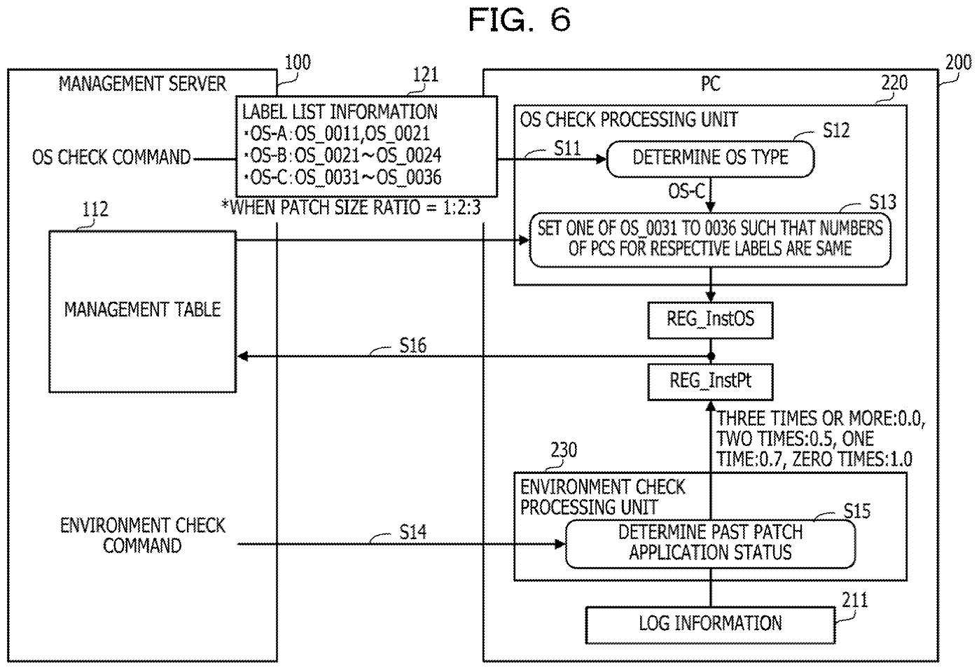

FIG. 6 is a diagram illustrating an overview of the processing for setting the registries used for grouping. First, setting of the registry REG_InstOS will be described.

Based on the software dictionary 111, the patch application control unit 120 of the management server 100 transmits the OS check command to all the PCs 200 at regular time intervals (step S11). Label list information 121 indicating a list of settable labels is added to the OS check command.

Upon receiving the OS check command, the OS check processing unit 220 of the PC 200 determines the OS type of the corresponding PC 200 (step S12). For example, information indicating a referenced file for determining the OS type is added to the OS check command, and the OS check processing unit 220 may determine the OS type by referring to the referenced file.

As an example, it is assumed that the OS type of the corresponding PC 200 is determined as the OS-C. Accordingly, the OS check processing unit 220 specifies OS_0031 to OS_0036 as the labels corresponding to the OS-C from the label list information 121. The OS check processing unit 220 sets one of OS_0031 to OS_0036 in the registry REG_InstOS such that the numbers of the PCs allocated for the respective labels are the same (step S13). Note that, this processing is executed only for the grouping target PCs among the PCs 200.

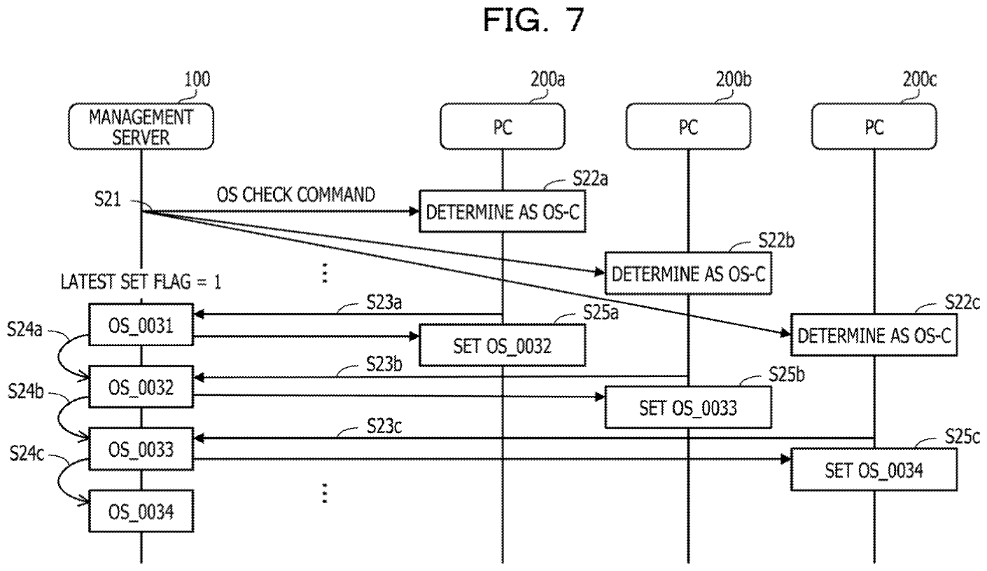

By the processing in step S13, the grouping target PC is assigned one of the labels corresponding to the OS type of the corresponding grouping target PC. As illustrated in FIG. 7 described below, this label assigning is executed by the management server 100 and the PC 200 cooperating with each other by using the management table 112.

FIG. 7 is a diagram illustrating the label assigning processing. As described above, the OS check command is transmitted from the management server 100 to the PCs 200a, 200b, 200c, . . . (step S21). It is assumed that the PCs 200a to 200c that have received the OS check command each determine the own OS type as the OS-C (steps S22a to S22c).

After determining the OS type, the PCs 200a to 200c transmits a label notification request for requesting a notification of the label with the latest set flag of 1 to the management server 100 while designating the determined OS type. In the example illustrated in FIG. 7, it is assumed that the label notification requests are transmitted to the management server 100 in the order of the PCs 200a, 200b, and 200c.

The PC 200a designates the OS-C as the OS type and transmits the label notification request to the management server 100 (step S23a). At this time, if the latest set flag for OS_0031 among the labels corresponding to OS-C is 1, the management server 100 notifies the PC 200a of OS_0031 as the label. Along with this, the management server 100 updates the latest set flag of OS_0031 to 0 and updates the latest set flag of OS_0032, which is the next label corresponding to the OS-C, to 1 (step S24a). The PC 200a sets OS_0032, which is the label following the notified OS_0031 among the labels corresponding to the OS-C, in the registry REG_InstOS in the PC 200a (step S25a).

The PC 200b designates the OS-C as the OS type and transmits the label notification request to the management server 100 (step S23b). At this time, since the latest set flag for OS_0032 among the labels corresponding to the OS-C is set to 1, the management server 100 notifies the PC 200b of OS_0032 as the label. Along with this, the management server 100 updates the latest set flag of OS_0032 to 0 and updates the latest set flag of OS_0033, which is the next label corresponding to the OS-C, to 1 (step S24b). The PC 200b sets OS_0033, which is the label following the notified OS_0032 among the labels corresponding to the OS-C, in the registry REG_InstOS in the PC 200b (step S25b).

The PC 200c designates the OS-C as the OS type and transmits the label notification request to the management server 100 (step S23c). At this time, since the latest set flag for OS_0033 among the labels corresponding to the OS-C is set to 1, the management server 100 notifies the PC 200c of OS_0033 as the label. Along with this, the server 100 updates the latest set flag of OS_0033 to 0 and updates the latest set flag of OS_0034, which is the next label corresponding to the OS-C, to 1 (step S24c). The PC 200c sets OS_0034, which is the label following the notified OS_0033 among the labels corresponding to the OS-C, in the registry REG_InstOS in the PC 200c (step S25c).

As described above, a label is sequentially assigned to each PC 200 of the same OS type by using the latest set flag managed on the management server 100 side. After the last label (OS_0036 in the example of FIG. 7) is assigned, the process returns to the first label (OS_0031), and the assigning is further continued sequentially. Thus, the labels are assigned such that the numbers of the PCs allocated for the respective labels corresponding to the same OS type are the same, and the assigned labels are set in the registry REG_InstOS.

Although the management server 100 notifies the PC of the label for which the latest set flag is currently set to 1 in the description of FIG. 7, as another example, the management server 100 may change the label for which the latest set flag is set to 1 to the next label and notify the PC of the label after the change. In this case, the PC 200 may set the notified label directly in the registry REG_InstOS.

Hereinafter, the setting of the registry REG_InstPt will be described with reference to FIG. 6.

Based on the software dictionary 111, the patch application control unit 120 of the management server 100 transmits the environment check command to all the PCs 200 at regular time intervals (step S14). For example, the transmission interval of the environment check command may be the same as the transmission interval of the OS check command.

First, the environment check processing unit 230 of the PC 200 determines whether the corresponding PC 200 is coupled to the internal network 301 or the Internet 302. For example, when the corresponding PC 200 is able to communicate with a proxy server over the internal network 301, it is determined that the corresponding PC 200 is coupled to the internal network 301.

When it is determined that the corresponding PC 200 is coupled to the Internet 302, the environment check processing unit 230 further determines the past patch application status (step S15). For example, the environment check processing unit 230 refers to the log information 211 to collect the past download histories of the patch and determines the download status via the VPN in the past and the download status from the OS vendor site in the past from the collection result. Based on the determination result, the environment check processing unit 230 sets, in the registry REG_InstPt, a weighting coefficient corresponding to the probability that the corresponding PC 200 downloads the patch via the VPN.

As an example, the environment check processing unit 230 determines, from the log information 211, the number of times that the patch is downloaded from the OS vendor site and applied within one week from the date of patch publication by the OS vendor in the latest three months. As the number of times is greater, it is estimated that the probability of downloading the patch via the VPN in the next patch application is lower. Accordingly, the environment check processing unit 230 sets the weighting coefficient to be smaller as the number of times of the determination is greater. As an example, when the number of times of the determination is three times or more, two times, one time, and zero times, 0.0, 0.5, 0.7, and 1.0 are set as the weighting coefficient, respectively. The environment check processing unit 230 sets such a weighting coefficient in the registry REG_InstPt.

According to the above procedure, the registry REG_InstOS and the registry REG_InstPt are periodically updated. The OS check processing unit 220 transmits the value set in the registry REG_InstPt together with the label set in the registry REG_InstOS to the management server 100 (step S16).

By the above-described processing, the patch application control unit 120 of the management server 100 is notified of the setting value (REG_InstPt value) in the registry REG_InstPt and the label from each of the grouping target PCs. Based on the notified information, the patch application control unit 120 performs grouping for each label by using the management table 112.

For example, when the REG_InstPt value and the label are notified, the patch application control unit 120 specifies a record corresponding to the notified label out of the records in the management table 112. The patch application control unit 120 adds the notified REG_InstPt value to the REG_InstPt total value of the specified record. Thus, the total value of the REG_InstPt values in all the PCs 200 to which the same label is assigned is registered as the REG_InstPt total value in the management table 112.

After a certain period of time elapses from the transmission of the OS check command, the patch application control unit 120 sums up the REG_InstPt total values registered in all the records in the management table 112. Based on the calculated total value, the patch application control unit 120 calculates the REG_InstPt ratio of each record in the management table 112. The REG_InstPt ratio is calculated by dividing the calculated total value by the REG_InstPt total value of the same record.

Based on the calculated REG_InstPt ratio, the patch application control unit 120 calculates the REG_Time value of each record (for example, the REG_Time value corresponding to each label). With this calculation, the REG_Time value is calculated such that the sum of the REG_InstPt ratios allocated to the same REG_Time value is “1/the number of groups”. The REG_Time value corresponding to the label indicates the group to which the PC 200 assigned with the label belongs.

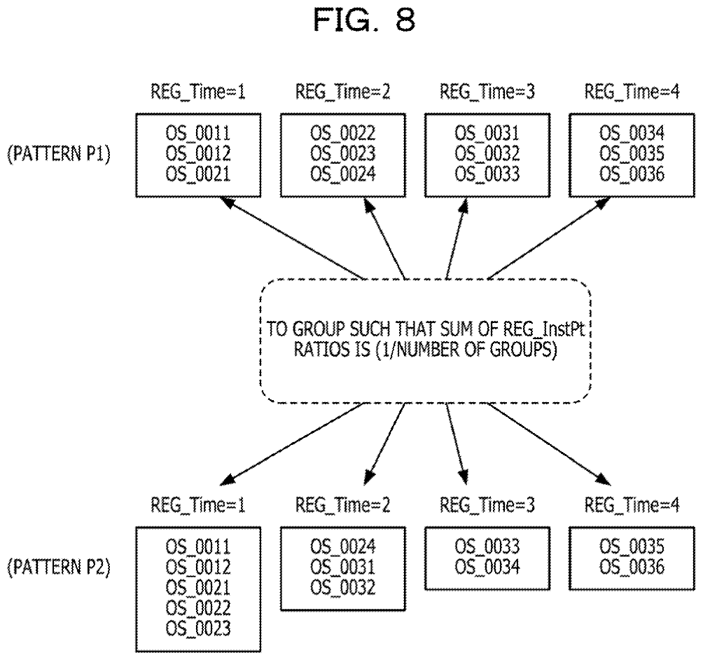

FIG. 8 is a diagram illustrating the label grouping processing. The REG_Time value corresponding to each label (for example, a group to which each label belongs) is determined such that the sum of the REG_InstPt ratios allocated to the same REG_Time value is “1/the number of groups”.

As described above, the number of the labels generated for each OS type is determined such that the ratio of the number of the labels for each OS type matches the ratio of the data size of the patch. The REG_InstPt ratio indicates a value obtained by multiplying the number of the PCs 200 assigned with the corresponding labels by the probability that the PCs 200 download the patch via the VPN.

For this reason, in a case where the ratio of the number of the PCs 200 in which the OS of each OS type operates is the same as the above ratio (for example, the numbers of the PCs 200 allocated to all the labels are the same), and the probability that each PC 200 downloads the patch via the VPN is also the same, it is possible to easily group the labels as illustrated in a pattern P1 in FIG. 8, for example. In this pattern P1, the amount of the downloaded patch for each group may be made uniform only by assigning the same number of labels to the same REG_Time value (for example, the number of labels for each group is made uniform). This is because, by increasing the number of the labels for an OS type having a greater patch data size, there is a higher probability that the PCs 200 of such an OS type are distributed and allocated to the greater number of different groups.

In reality, there is a high probability that the ratio of the number of the PCs 200 in which the OS of each OS type operates does not coincide with the ratio of the patch data size as described above. The probability of downloading the patch via the VPN is not necessarily the same for each PC 200. A reason for the latter is that there is the probability that the PC 200 downloads the patch from the OS vendor site, and the number of the PCs 200 coupled to the Internet 302 instead of the internal network 301 is not fixed at all times.

Therefore, in reality, there is a high probability that the numbers of the labels assigned to the same REG_Time value (for example, the same group) are not the same as illustrated in a pattern P2 in FIG. 8, for example. By grouping the labels based on the REG_Time ratio, which is an index in consideration of the number of the PCs 200 for each label and the probability that the PC 200 downloads the patch via the VPN, it is possible to substantially equalize the amount of the downloaded patch via the VPN for each group.

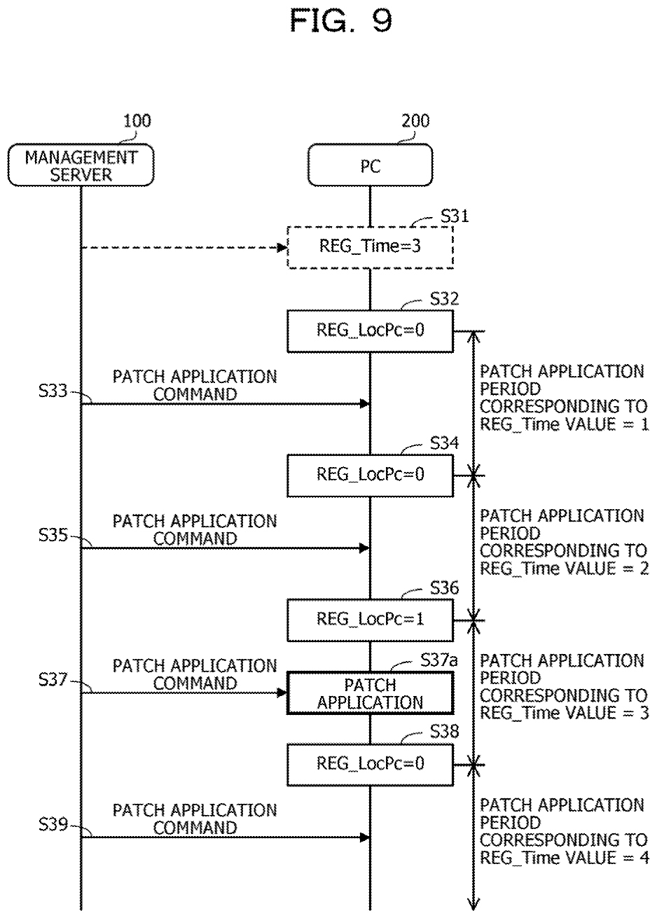

FIG. 9 is a diagram illustrating the patch application timing for each group. After transmitting the REG_InstOS value and the REG_InstPt value in step S16 in FIG. 6, the OS check processing unit 220 of the grouping target PC obtains the REG_Time value corresponding to the REG_InstOS value (label) from the management server 100. The OS check processing unit 220 sets the obtained REG_Time value in the registry REG_Time (step S31). In the example illustrated in FIG. 9, it is assumed that 3 is set as the REG_Time value in the registry REG_Time.

On the other hand, after setting the registry REG_InstPt as illustrated in FIG. 6, the environment check processing unit 230 of the grouping target PC reads the setting value in the registry REG_Time. The environment check processing unit 230 then autonomously specifies the periodic patch application period corresponding to each of the REG_Time values and sets 1 in the registry REG_LocPc in the patch application period corresponding to the setting value in the registry REG_Time.

The patch application control unit 120 of the management server 100 repeatedly transmits the patch application command for instructing patch application at least as many times as the number of the groups at the same cycle as the appearance cycle of the patch application period for each REG_Time value. Upon receiving the patch application command, the patch application processing unit 240 of the PC 200 reads the setting value in the registry REG_Time and executes the patch application processing only when the setting value is 1.

In the example illustrated in FIG. 9, the environment check processing unit 230 of the PC 200 keeps the registry REG_LocPc at 0 at the start timing of the patch application period corresponding to REG_Time value=1 (step S32). When the patch application command is transmitted in this period (step S33), the patch application processing unit 240 of the PC 200 receives this patch application command. Since the registry REG_LocPc is 0, the patch application processing unit 240 does not apply the patch.

At the start timing of the patch application period corresponding to REG_Time value=2, the environment check processing unit 230 of the PC 200 keeps the registry REG_LocPc at 0 (step S34). When the patch application command is transmitted in this period (step S35), the patch application processing unit 240 of the PC 200 receives this patch application command. Since the registry REG_LocPc is 0, the patch application processing unit 240 does not apply the patch.

At the start timing of the patch application period corresponding to REG_Time value=3, the environment check processing unit 230 of the PC 200 updates the registry REG_LocPc to 1 (step S36). When the patch application command is transmitted in this period (step S37), the patch application processing unit 240 of the PC 200 receives this patch application command. Since the registry REG_LocPc is 1, the patch application processing unit 240 downloads the patch from the management server 100 via the VPN and applies the patch to the PC 200 (step S37a). At this time, the registry REG_LocPc is updated to 0.

At the start timing of the patch application period corresponding to REG_Time value=4, the environment check processing unit 230 of the PC 200 keeps the registry REG_LocPc at 0 (step S38). When the patch application command is transmitted in this period (step S39), the patch application processing unit 240 of the PC 200 receives this patch application command. Since the registry REG_LocPc is 0, the patch application processing unit 240 does not apply the patch.

As described above, the PC 200 sets 1 in the registry REG_LocPc in the patch application period corresponding to the setting value in the registry REG_Time. Upon receiving the patch application command, the PC 200 performs the patch application if the registry REG_LocPc is 1. Accordingly, the patch download timings via the VPN are staggered for each group, and the amount of the downloaded data of the patch via the VPN may be substantially distributed uniformly among the groups.

The transmission interval of the patch application command illustrated in FIG. 9 (the execution interval in steps S33, S35, S37, and S39) is set shorter than the transmission intervals of the OS check command and the environment check command. For example, the transmission interval of the patch application command is set to a length equal to or shorter than “1/the number of groups” of the transmission intervals of the OS check command and the environment check command.

The patch application periods for the respective REG_Time values are synchronized among the PCs 200. For example, each PC 200 determines the start timing of the patch application period based on a predetermined reference clock time. Alternatively, while the determination of the patch application period is repeatedly executed at all times, the patch application command is transmitted only when a new patch is generated. For this reason, for example, the start timing of the patch application period may be determined based on the timing at which the patch application command is first transmitted after a new patch is generated.

Next, processing by the management server 100 and the PC 200 is described by using a flowchart.

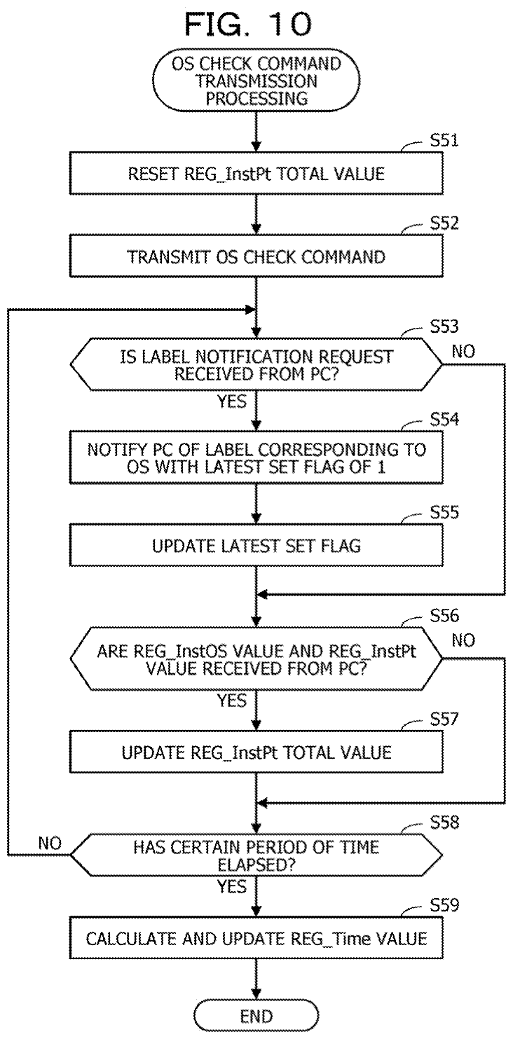

FIG. 10 is an example of a flowchart illustrating a procedure of the OS check command transmission processing by the management server. The patch application control unit 120 of the management server 100 repeatedly executes the processing in FIG. 10 at regular time intervals.

[step S51] The patch application control unit 120 resets the REG_InstPt total value of all the records in the management table 112 to 0.

[step S52] Based on the software dictionary 111, the patch application control unit 120 simultaneously transmits the OS check command to all the PCs 200. At this time, the OS check command is transmitted while the label list information 121 in which the list of the labels corresponding to each OS type is described and the number of the groups into which the PCs 200 are classified are added to the OS check command.

[step S53] The patch application control unit 120 determines whether the label notification request for requesting the notification of the label with the latest set flag of 1 is received from the PC 200 (actually, the grouping target PC). When the label notification request is received, the process proceeds to step S54, and when no label notification request is received, the process proceeds to step S56.

[step S54] The OS type is added to the received label notification request. By referring to the management table 112, the patch application control unit 120 determines the label with the latest set flag of 1 out of the labels corresponding to the OS type (the REG_InstOS values) added to the label notification request. The patch application control unit 120 transmits the value of the determined label to the PC that transmits the label notification request. It is assumed that at an initial state, the label for which the latest set flag is set to 1 is determined in advance for each OS type.

[step S55] For the label corresponding to the OS type added to the label notification request, the patch application control unit 120 changes the label for which the latest set flag is set to 1 to the next label. For example, the latest set flag corresponding to the label determined in step S54 is updated to 0, and the latest set flag of the next label corresponding to the same OS type is updated from 0 to 1.

[step S56] The patch application control unit 120 determines whether a pair of data of the REG_InstOS value and the REG_InstPt value is received from the PC 200 (actually, the grouping target PC). When the pair of data is received, the process proceeds to step S57, and when no pair of data is received, the process proceeds to step S58.

[step S57] The patch application control unit 120 updates the REG_InstPt total value in the management table 112 by adding the received REG_InstPt value to the REG_InstPt total value associated with the received REG_InstOS value.

[step S58] The patch application control unit 120 determines whether a certain period of time has elapsed since the transmission of the OS check command in step S52. The certain period of time may be set to a value equal to or shorter than the transmission cycle of the OS check command (the execution cycle of the processing in FIG. 10). When the certain period of time has not elapsed, the process proceeds to step S53, and when the certain period of time has elapsed, the process proceeds to step S59.

[step S59] The patch application control unit 120 calculates and updates the REG_Time value of each record in the management table 112. In this processing, first, the patch application control unit 120 sums up the REG_InstPt total values registered in all the records in the management table 112. For each record in the management table 112, the patch application control unit 120 divides the calculated total value by the REG_InstPt total value and updates the value of the REG_InstPt ratio with the obtained divided value. Based on the REG_InstPt ratio, the patch application control unit 120 determines the REG_Time value to be allocated to each label, and updates the REG_Time value in the management table 112 with the determined REG_Time value.

For example, the REG_Time value is determined as follows. The patch application control unit 120 sequentially selects and combines the labels from the top side of the management table 112, and allocates, to the same REG_Time value, a maximum number of combinations of labels in which the sum of the REG_InstPt ratios of the combined labels is equal to or smaller than the value of “1/the number of groups”. By executing such processing sequentially from the top side of the management table 112, any REG_Time value (for example, any group) is allocated to each label. All the remaining labels may be assigned to the final group.

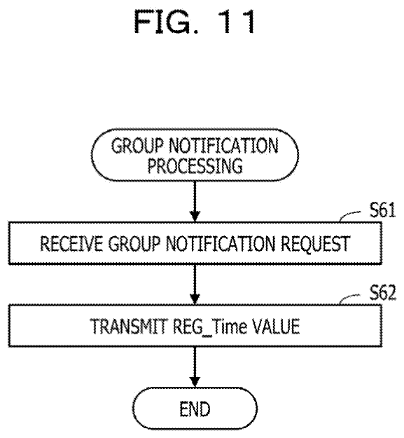

In addition to the processing in FIG. 10, the patch application control unit 120 executes the group notification processing illustrated in FIG. 11 described below.

FIG. 11 is an example of a flowchart illustrating a procedure of the group notification processing.

[step S61] Upon receiving the group notification request in which the value of the label is designated from the PC 200 (actually, the grouping target PC), the patch application control unit 120 executes the processing in the following step S62.

[step S62] The patch application control unit 120 reads the REG_Time value corresponding to the designated label from the management table 112 and transmits the REG_Time value to the PC that transmits the group notification request.

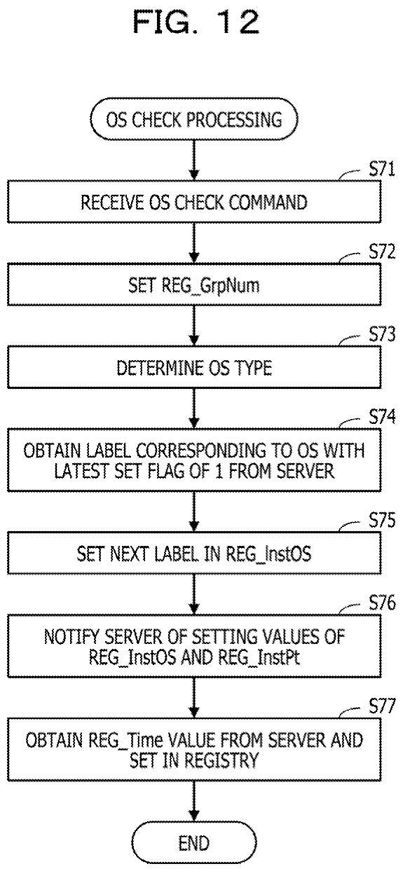

FIG. 12 is an example of a flowchart illustrating a procedure of the OS check processing by the PC.

[step S71] Upon receiving the OS check command from the management server 100, the OS check processing unit 220 of the PC 200 executes the processing in and after step S72.

[step S72] The OS check processing unit 220 sets the number of the groups added to the OS check command in the registry REG_GrpNum.

[step S73] Based on the information added to the OS check command, the OS check processing unit 220 determines the type of the OS operating in the corresponding PC 200. For example, the OS type is determined by referring to a file designated by the information added to the OS check command.

[step S74] The OS check processing unit 220 transmits the label notification request for requesting the notification of the label with the latest set flag of 1 to the management server 100 while designating the determined OS type. As a response to the label notification request, the OS check processing unit 220 obtains the corresponding label from the management server 100.

[step S75] The OS check processing unit 220 extracts the labels corresponding to the OS type determined in step S73 from the label list information 121 added to the OS check command. The OS check processing unit 220 sets, in the registry REG_InstOS, the label following the label obtained in step S74 out of the extracted labels. Thus, the label is assigned to the corresponding PC 200 such that the number of the PCs allocated to each label corresponding to the same OS type is the same.

[step S76] The OS check processing unit 220 notifies the management server 100 of the values currently set in the registries REG_InstOS and REG_InstPt.

[step S77] The OS check processing unit 220 designates the label set in the registry REG_InstOS in step S75 and transmits the group notification request to the management server 100. As a response to the group notification request, the OS check processing unit 220 obtains the REG_Time value associated with the label from the management server 100 and sets the obtained REG_Time value in the registry REG_Time. The processing in step S77 may be periodically executed asynchronously with the processing in steps S71 to S76.

Processing in steps S74 to S77 described above is executed only when the corresponding PC 200 is coupled to the Internet 302. For example, when the setting value in the registry REG_InstPt is NULL, it is determined that the corresponding PC 200 is coupled to the Internet 302. When the corresponding PC 200 is coupled to the internal network 301, the OS check processing unit 220 sets, in the registry REG_InstOS, a predetermined label (for example, the first label) out of the labels corresponding to the OS type determined in step S73.

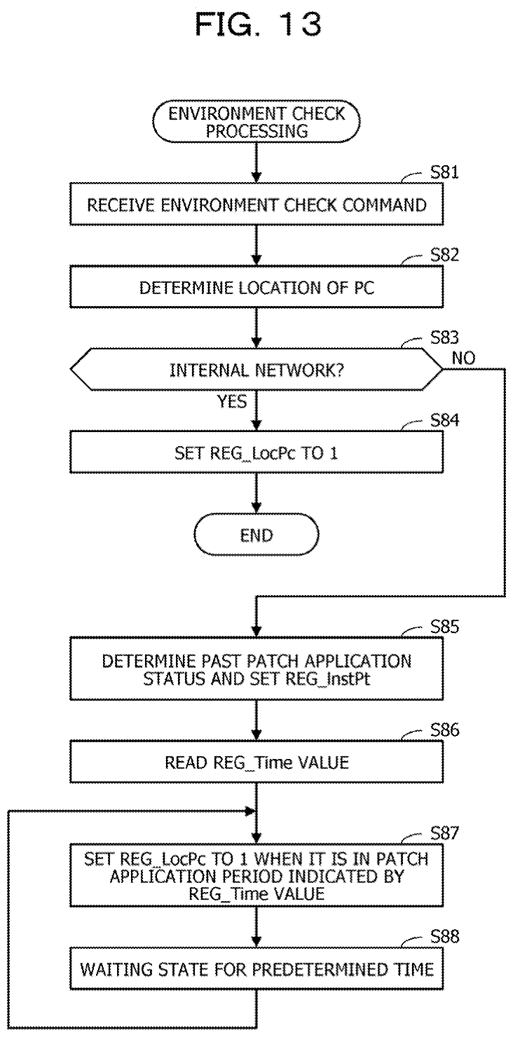

FIG. 13 is an example of a flowchart illustrating a procedure of the environment check processing by the PC.

[step S81] Upon receiving the environment check command from the management server 100, the environment check processing unit 230 in the PC 200 executes the processing in and after step S82.

[step S82] The environment check processing unit 230 determines the location of the corresponding PC 200, for example, whether the corresponding PC 200 is coupled to the internal network 301 or the Internet 302. For example, when the corresponding PC 200 is able to communicate with a proxy server over the internal network 301, it is determined that the corresponding PC 200 is coupled to the internal network 301.

[step S83] When the corresponding PC 200 is coupled to the internal network 301, the process proceeds to step S84, and when the corresponding PC 200 is coupled to the Internet 302, the process proceeds to step S85.

[step S84] The environment check processing unit 230 sets 1 in the registry REG_LocPc. The environment check processing unit 230 updates the setting value in the registry REG_InstPt to NULL.

[step S85] The environment check processing unit 230 determines the past patch application status by referring to the log information 211. For example, the environment check processing unit 230 collects the past download history of the patch from the log information 211 and determines the download status via the VPN in the past and the download status from the OS vendor site in the past from the collection result. Based on the determination result, the environment check processing unit 230 sets, in the registry REG_InstPt, a weighting coefficient corresponding to the probability that the corresponding PC 200 downloads the patch via the VPN.

[step S86] The environment check processing unit 230 reads the value set in the registry REG_Time.

[step S87] The patch application period corresponding to one of possible values as the REG_Time value is started. When the current patch application period is the period corresponding to the REG_Time value read in step S86, the environment check processing unit 230 sets 1 in the registry REG_LocPc. On the other hand, when it is not the corresponding period, the environment check processing unit 230 updates the setting value in the registry REG_LocPc to 0 if the setting value is 1, and keeps the setting value as it is if the setting value is 0.

[step S88] The environment check processing unit 230 enters a waiting state for a predetermined time. This predetermined time is the same as the transmission cycle of the patch update command for each group from the management server 100. After the predetermined time has elapsed, the patch application period corresponding to the next REG_Time value is started, and the process proceeds to step S87.

Every time the loop processing in steps S87 and S88 is repeated, it is determined in step S87 that the patch application period corresponding to the next REG_Time value has been started. The maximum value as the REG_Time value, for example, the number of the groups is determined from the setting value in the registry REG_GrpNum. For example, in a case where the number of the groups is four, when the patch application period of the REG_Time value of 4 ends, it is determined that the next patch application period is a period corresponding to the REG_Time value of 1.

The loop processing in steps S87 and S88 ends when the environment check command is received from the management server 100.

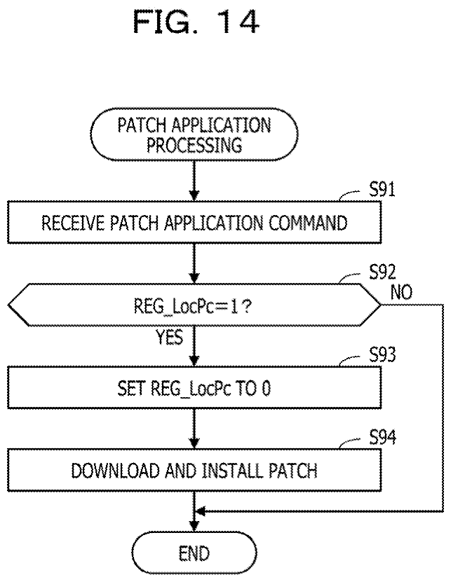

FIG. 14 is an example of a flowchart illustrating a procedure of the patch application processing by the PC. FIG. 14 illustrates processing in which the update data is downloaded via the VPN in accordance with the patch application command from the management server 100. However, the PC 200 (grouping target PC) coupled to the Internet 302 may download the patch from the OS vendor site over the Internet 302 regardless of the patch application command. For example, when instructed to download a new patch from the OS vendor site, the grouping target PC for which automatic update of the OS is set downloads the patch from the OS vendor site in accordance with the instruction.

When a new patch is released, the patch application control unit 120 of the management server 100 repeatedly transmits the patch application command to all the PCs 200 at least as many times as the number of the groups at the same cycle as the length of the patch application period for each REG_Time value (for example, for each group).

[step S91] Upon receiving the patch application command from the management server 100, the patch application processing unit 240 in the PC 200 executes the processing in and after step S92.

[step S92] The patch application processing unit 240 reads the value set in the registry REG_LocPc. When the setting value is 1, the processing proceeds to step S93, and when the setting value is 0, steps S93 and S94 are skipped, and the patch application processing ends.

[step S93] The patch application processing unit 240 updates the setting value in the registry REG_LocPc to 0.

[step S94] The patch application processing unit 240 recognizes the OS type of the corresponding PC 200 from, for example, the setting value in the registry REG_InstPt or the determination result in step S73 in FIG. 12, and downloads the patch corresponding to the OS type from the management server 100. When the corresponding PC 200 is coupled to the Internet 302, the patch is downloaded via the VPN. For example, the location of the download source is added to the received patch application command. The patch application processing unit 240 installs the downloaded patch into the corresponding PC 200.

By the above-described processing, the grouping target PC downloads the patch from the management server 100 via the VPN in the patch application period corresponding to the REG_Time value allocated to the concerned grouping target PC (for example, the group to which the concerned grouping target PC belongs). However, in step S94, when the same patch has already been downloaded from the OS vendor server, the patch application processing unit 240 does not download the patch from the management server 100. As described above, since the grouping target PCs are grouped in consideration of the probability that the patch is downloaded without via the VPN, it is possible to make the amount of the downloaded patch for each group via the VPN close to uniformity.

In the processing in FIG. 14, the PC 200 coupled to the internal network 301 downloads the patch from the management server 100 in the first patch application period (when the first patch application command is received after the release of the patch).

The processing functions of the apparatuses (for example, the information processing apparatuses 10a, 10b, 10c, . . . , the management apparatus 20, the management server 100, and the PC 200) described in each embodiment described above may be implemented by a computer. In such a case, a program describing the details of the processing of the functions to be included in each apparatus is provided, and with a computer executing the program, the above-described processing functions are implemented over the computer. The program describing the details of the processing may be recorded in a computer-readable recording medium. The computer-readable recording medium may be a magnetic storage device, an optical disc, a semiconductor memory, or the like. The magnetic storage device may be a hard disk drive (HDD), a magnetic tape, or the like. The optical disc may be a compact disc (CD), a Digital Versatile Disc (DVD), a Blu-ray disc (BD, registered trademark), or the like.

When the program is distributed, for example, a portable recording medium such as a DVD or a CD in which the program is recorded is sold. The program may also be stored in a storage device of a server computer and be transferred from the server computer to another computer via a network.

The computer that executes the program stores, in a storage device thereof, the program recorded in the portable recording medium or the program transferred from the server computer, for example. The computer reads the program from the storage device thereof and performs processing according to the program. The computer may also read the program directly from the portable recording medium and perform processing according to the program. Each time the program is transferred from the server computer coupled to the computer via the network, the computer may also sequentially perform processing according to the received program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system, comprising:
a plurality of information processing apparatuses each including a first processor; and
a management apparatus that includes a second processor and is coupled to the plurality of information processing apparatuses via a first transfer path, wherein
the first processor of each of the plurality of information processing apparatuses is configured to:
estimate a probability of downloading update data via the first transfer path based on history information that indicates via which one of the first transfer path and a second transfer path the update data that corresponds to a program that operates in the information processing apparatus has been downloaded;
transmit index information that corresponds to an estimation result of the probability to the management apparatus;
receive classification information that indicates to which of a plurality of groups the information processing apparatus is classified from the management apparatus;
determine a group to which the information processing apparatus belongs out of the plurality of groups based on the classification information; and
download the update data at a timing that corresponds to the determined group, and
the second processor of the management apparatus configured to:
classify each of the plurality of information processing apparatuses into one of the plurality of groups based on the index information received from each of the plurality of information processing apparatuses; and
transmit the classification information that indicates the classification result to the plurality of information processing apparatuses.

2. The information processing system according to claim 1, wherein
the first processor of each of the plurality of information processing apparatuses determines a type of a program that operates in the information processing apparatus out of a plurality of types of programs and transmits determination information that corresponds to the determination result of the type to the management apparatus together with the index information, and
the second processor of the management apparatus classifies each of the plurality of information processing apparatuses into one of the plurality of groups based on the index information and the determination information received from each of the plurality of information processing apparatuses and a data size of the update data that corresponds to each of the plurality of types of programs.

3. The information processing system according to claim 2, wherein
one or more pieces of identification information are generated for each of the plurality of types of programs such that a greater number of pieces of identification information are generated as the data size of the update data is greater,
out of the identification information that corresponds to the program that operates in the information processing apparatus, the first processor of each of the plurality of information processing apparatuses allocates the identification information to the information processing apparatus such that the number of pieces of the identification information allocated to the information processing apparatuses in which the same type of program operates is uniform, and transmits the allocated identification information as the determination information to the management apparatus,
the second processor of the management apparatus classifies the identification information that corresponds to all of the plurality of types of programs into one of the plurality of groups based on the index information and the determination information received from each of the plurality of information processing apparatuses, and transmits, to the plurality of information processing apparatuses, information that indicates a result of allocation of the group to the identification information as the classification information, and
based on the received classification information, the first processor of each of the plurality of information processing apparatuses recognizes a group associated with the identification information allocated to the information processing apparatus as a group to which the information processing apparatus belongs.

4. The information processing system according to claim 3, wherein
based on the index information and the determination information received from each of the plurality of information processing apparatuses, the second processor of the management apparatus calculates a total value of the received index information for the respective pieces of identification information that correspond to all of the plurality of types of programs, calculates, for each piece of identification information, a ratio of the total value to a whole total value obtained by summing up all of the total values, and classifies the identification information into one of the plurality of groups such that the total values of the ratios in the respective plurality of groups are equal to each other.

5. The information processing system according to claim 3, wherein
out of the pieces of identification information that correspond to the programs, the second processor of the management apparatus records the identification information most recently allocated by the first processor of any of the plurality of information processing apparatuses into management information, for each of the plurality of types of programs, and
at the time of allocating of the identification information to the information processing apparatus, the first processor of each of the plurality of information processing apparatuses obtains the identification information that is allocated most recently and recorded in the management information, and allocates, to the information processing apparatus, the identification information that differs from the identification information that is allocated most recently, thereby allocating the identification information to the information processing apparatus such that the number of pieces of the identification information allocated to the information processing apparatuses in which the same type of program operates is uniform.

6. A non-transitory computer-readable recording medium recording an information program causing a computer, which is coupled to the plurality of information processing apparatuses each including a first processor via a first transfer path, to execute a processing, the processing comprising:
receiving, from the respective information processing apparatuses, index information that corresponds to an estimation result of a probability of downloading update data via the first transfer path which is estimated based on history information that indicates via which one of the first transfer path and a second transfer path the update data that corresponds to a program that operates in the respective information processing apparatuses has been downloaded;
classifying each of the plurality of information processing apparatuses into one of a plurality of groups of which timings to download the update data are different from each other based on the index information received from each of the plurality of information processing apparatuses; and
transmitting classification information that indicates the classification result to the plurality of information processing apparatuses.

7. The non-transitory computer-readable recording medium according to claim 6, wherein
the first processor of each of the plurality of information processing apparatuses determines a type of a program that operates in the information processing apparatus out of a plurality of types of programs and transmits determination information that corresponds to the determination result of the type to the computer together with the index information, and
the computer classifies each of the plurality of information processing apparatuses into one of the plurality of groups based on the index information and the determination information received from each of the plurality of information processing apparatuses and a data size of the update data that corresponds to each of the plurality of types of programs.

8. The non-transitory computer-readable recording medium according to claim 7, wherein
one or more pieces of identification information are generated for each of the plurality of types of programs such that a greater number of pieces of identification information are generated as the data size of the update data is greater,
out of the identification information that corresponds to the program that operates in the information processing apparatus, the first processor of each of the plurality of information processing apparatuses allocates the identification information to the information processing apparatus such that the number of pieces of the identification information allocated to the information processing apparatuses in which the same type of program operates is uniform, and transmits the allocated identification information as the determination information to the computer,
the computer classifies the identification information that corresponds to all of the plurality of types of programs into one of the plurality of groups based on the index information and the determination information received from each of the plurality of information processing apparatuses, and transmits, to the plurality of information processing apparatuses, information that indicates a result of allocation of the group to the identification information as the classification information, and
based on the received classification information, the first processor of each of the plurality of information processing apparatuses recognizes a group associated with the identification information allocated to the information processing apparatus as a group to which the information processing apparatus belongs.

9. The non-transitory computer-readable recording medium according to claim 8, wherein
based on the index information and the determination information received from each of the plurality of information processing apparatuses, the computer calculates a total value of the received index information for the respective pieces of identification information that correspond to all of the plurality of types of programs, calculates, for each piece of identification information, a ratio of the total value to a whole total value obtained by summing up all of the total values, and classifies the identification information into one of the plurality of groups such that the total values of the ratios in the respective plurality of groups are equal to each other.

10. The non-transitory computer-readable recording medium according to claim 8, wherein
out of the pieces of identification information that correspond to the programs, the computer records the identification information most recently allocated by the first processor of any of the plurality of information processing apparatuses into management information, for each of the plurality of types of programs, and
at the time of allocating of the identification information to the information processing apparatus, the first processor of each of the plurality of information processing apparatuses obtains the identification information that is allocated most recently and recorded in the management information, and allocates, to the information processing apparatus, the identification information that differs from the identification information that is allocated most recently, thereby allocating the identification information to the information processing apparatus such that the number of pieces of the identification information allocated to the information processing apparatuses in which the same type of program operates is uniform.

11. An information processing method comprising:
receiving, by a computer which is coupled to a plurality of information processing apparatuses each including a first processor via a first transfer path, from the respective information processing apparatuses, index information that corresponds to an estimation result of a probability of downloading update data via the first transfer path which is estimated based on history information that indicates via which one of the first transfer path and a second transfer path the update data that corresponds to a program that operates in the respective information processing apparatuses has been downloaded;
classifying each of the plurality of information processing apparatuses into one of a plurality of groups of which timings to download the update data are different from each other based on the index information received from each of the plurality of information processing apparatuses; and
transmitting classification information that indicates the classification result to the plurality of information processing apparatuses.

12. The information processing method according to claim 11, wherein
the first processor of each of the plurality of information processing apparatuses determines a type of a program that operates in the information processing apparatus out of a plurality of types of programs and transmits determination information that corresponds to the determination result of the type to the computer together with the index information, and
the computer classifies each of the plurality of information processing apparatuses into one of the plurality of groups based on the index information and the determination information received from each of the plurality of information processing apparatuses and a data size of the update data that corresponds to each of the plurality of types of programs.

13. The information processing method according to claim 12, wherein
one or more pieces of identification information are generated for each of the plurality of types of programs such that a greater number of pieces of identification information are generated as the data size of the update data is greater,
out of the identification information that corresponds to the program that operates in the information processing apparatus, the first processor of each of the plurality of information processing apparatuses allocates the identification information to the information processing apparatus such that the number of pieces of the identification information allocated to the information processing apparatuses in which the same type of program operates is uniform, and transmits the allocated identification information as the determination information to the computer,
the computers classifies the identification information that corresponds to all of the plurality of types of programs into one of the plurality of groups based on the index information and the determination information received from each of the plurality of information processing apparatuses, and transmits, to the plurality of information processing apparatuses, information that indicates a result of allocation of the group to the identification information as the classification information, and
based on the received classification information, the first processor of each of the plurality of information processing apparatuses recognizes a group associated with the identification information allocated to the information processing apparatus as a group to which the information processing apparatus belongs.

14. The information processing method according to claim 13, wherein
based on the index information and the determination information received from each of the plurality of information processing apparatuses, the computer calculates a total value of the received index information for the respective pieces of identification information that correspond to all of the plurality of types of programs, calculates, for each piece of identification information, a ratio of the total value to a whole total value obtained by summing up all of the total values, and classifies the identification information into one of the plurality of groups such that the total values of the ratios in the respective plurality of groups are equal to each other.

15. The information processing method according to claim 13, wherein
out of the pieces of identification information that correspond to the programs, the computer records the identification information most recently allocated by the first processor of any of the plurality of information processing apparatuses into management information, for each of the plurality of types of programs, and
at the time of allocating of the identification information to the information processing apparatus, the first processor of each of the plurality of information processing apparatuses obtains the identification information that is allocated most recently and recorded in the management information, and allocates, to the information processing apparatus, the identification information that differs from the identification information that is allocated most recently, thereby allocating the identification information to the information processing apparatus such that the number of pieces of the identification information allocated to the information processing apparatuses in which the same type of program operates is uniform.
